(19) United States
(12) Patent Application Publication
(10) Pub. No.: US 2025/0149775 A1
(43) Pub. Date: May 8, 2025

(54) ANTENNA SYSTEM FOR USE WITH INTEGRATED CONNECTOR MODULE

(71) Applicant: TAOGLAS GROUP HOLDINGS LIMITED, Enniscorthy (IE)

(72) Inventors: Olivier Robin, Black Diamond, WA (US); Lukas van Vuuren, Dublin (IE)

(21) Appl. No.: 18/931,375

(22) Filed: Oct. 30, 2024

Related U.S. Application Data
(60) Provisional application No. 63/547,604, filed on Nov. 7, 2023.

(51) Int. Cl. H01Q 1/22; H01Q 1/08; H01R 27/02

(52) U.S. Cl. CPC H01Q 1/2275; H01Q 1/08; H01R 27/02; H01R 2201/02

(57) ABSTRACT

Antenna system for use with an integrated connector module. In one embodiment, the antenna system is intended for use with an RJ-style connector and includes an antenna carrier that has an RJ-style connector clearance area. The RJ-style connector clearance area is sized to accommodate portions of an RJ-style connector. The antenna system also includes a printed circuit board that is configured to be disposed about distinct sides of the antenna carrier and a coaxial wire that is connected with the printed circuit board. Antenna on magnetics systems that include the aforementioned antenna system as well as printed circuit board antenna designs are also disclosed.

### CROSS-REFERENCE TO RELATED APPLICATIONS

This application claims the benefit of priority to U.S. Provisional Pat. App. Ser. No. 63/547,604 filed Nov. 7, 2023, of the same title, the contents of which being incorporated herein by reference in its entirety.

### TECHNOLOGICAL FIELD

The present disclosure relates generally to antenna systems for use with an electronic connector assembly, and specifically in one exemplary aspect to antenna designs used for transmitting and/or receiving wireless data while being assembled with an integrated connector module (ICM).

### FIELD OF THE DISCLOSURE

Existing telecommunications standards such as Ethernet (e.g., IEEE 802.3 et seq.) provide the capability to deliver data over standard telecommunications cabling such as ethernet cable. Further, existing wireless standards such as, for example, IEEE 802.11 et seq., permit data delivery over wireless networks. Various connectors and antenna structures exist in the prior art to facilitate the interconnection of both wired and wireless electronic components in systems employing both non-standard and standard telecommunications protocols such as the aforementioned Ethernet family of standards.

However, despite the broad variety of extant solutions, there remains a salient need for standard low-cost components and manufacturing methodologies that integrate both wired and wireless solutions into a single component or platform. Ideally, such a wired and wireless data networking device and methodologies would: (1) minimize component cost by integrating wired and wireless networking components; (2) simplify manufacturing and performance validation for suppliers of networked equipment; (3) provide effective shielding for electronic components (both internally and externally) from adverse electromagnetic noise; and (4) conserve physical space and board real estate within space-critical applications such as, for example, mobile or embedded devices.

### SUMMARY

The present disclosure satisfies the foregoing needs by providing, inter alia, methods, apparatus, and systems for the integration of one or more antenna systems with, for example, RJ-style connectors that incorporate ethernet signal magnetics (e.g., so-called Integrated Connector Modules (ICMs)) that address one or more of the deficiencies recognized above.

In one aspect, an antenna on magnetics system is disclosed. In one embodiment, the antenna on magnetics system includes an RJ-style connector; and an antenna system. The antenna system includes an antenna carrier having an RJ-style connector clearance area, the RJ-style connector clearance area being sized to accommodate portions of the RJ-style connector; a printed circuit board that is configured to be disposed about a plurality of distinct sides of the antenna carrier; and a coaxial wire, the coaxial wire being connected with the printed circuit board.

In one variant, the antenna carrier includes a top side that is oriented parallel with a top side of the RJ-style connector, a back side that is oriented generally orthogonal with the top side of the antenna carrier, and a bottom side that is oriented adjacent to the RJ-style connector when the antenna carrier is mounted thereon, the bottom side being parallel with the top side of the antenna carrier.

In another variant, the printed circuit board includes a flexible printed circuit board and the distinct sides of the antenna carrier includes the top side of the antenna carrier, the back side of the antenna carrier, and the bottom side of the antenna carrier.

In yet another variant, the printed circuit board includes an antenna ground, the antenna ground being located on both the back side of the antenna carrier and the bottom side of the antenna carrier when the printed circuit board is mounted on the antenna carrier.

In yet another variant, the printed circuit board includes a U-shaped radiator and an L-shaped radiator, the U-shaped radiator and the L-shaped radiator being located on the top side of the antenna carrier when the printed circuit board is mounted on the antenna carrier.

In yet another variant, the antenna carrier includes a connection clearance area and a coaxial clearance ledge, the connection clearance area and the coaxial clearance ledge enabling the coaxial wire to be attached to the printed circuit board at a position below the top side of the antenna carrier.

In yet another variant, the printed circuit board includes a ground connection for the coaxial wire and a feed connection for the coaxial wire, the ground connection and the feed connection being oriented orthogonal with the top side of the antenna carrier when the printed circuit board is mounted on the antenna carrier.

In yet another variant, the ground connection for the coaxial wire and the feed connection for the coaxial wire are also oriented orthogonal with the back side of the antenna carrier when the printed circuit board is mounted on the antenna carrier.

In yet another variant, a top portion of the U-shaped radiator extends from a left-hand portion of the printed circuit board towards a mid-line of the printed circuit board.

In yet another variant, the RJ-style connector includes shielding and conductive foam is disposed between the RJ-style connector shielding and the antenna ground disposed on the bottom side of the antenna carrier.

In another aspect, an antenna system is disclosed. In one embodiment, an antenna system for use with an RJ-style connector is disclosed which includes an antenna carrier having an RJ-style connector clearance area, the RJ-style connector clearance area being sized to accommodate portions of an RJ-style connector; a printed circuit board that is configured to be disposed about a plurality of distinct sides of the antenna carrier; and a coaxial wire, the coaxial wire being connected with the printed circuit board.

In one variant, the antenna carrier includes a top side that is oriented parallel with a top side of the RJ-style connector, a back side that is oriented generally orthogonal with the top side of the antenna carrier, and a bottom side that is oriented adjacent to the RJ-style connector when the antenna carrier is mounted thereon, the bottom side being parallel with the top side of the antenna carrier.

In another variant, the printed circuit board includes a flexible printed circuit board and the plurality of distinct sides of the antenna carrier include the top side of the antenna carrier, the back side of the antenna carrier, and the bottom side of the antenna carrier.

In yet another variant, the printed circuit board includes an antenna ground, the antenna ground being located on both the back side of the antenna carrier and the bottom side of the antenna carrier when the printed circuit board is mounted on the antenna carrier.

In yet another variant, the printed circuit board includes a U-shaped radiator and an L-shaped radiator, the U-shaped radiator and the L-shaped radiator being located on the top side of the antenna carrier when the printed circuit board is mounted on the antenna carrier.

In yet another variant, the antenna carrier includes a connection clearance area and a coaxial clearance ledge, the connection clearance area and the coaxial clearance ledge enabling the coaxial wire to be attached to the printed circuit board at a position below the top side of the antenna carrier.

In yet another variant, the printed circuit board includes a ground connection for the coaxial wire and a feed connection for the coaxial wire, the ground connection and the feed connection being oriented orthogonal with the top side of the antenna carrier when the printed circuit board is mounted on the antenna carrier.

In yet another variant, the ground connection for the coaxial wire and the feed connection for the coaxial wire are also oriented orthogonal with the back side of the antenna carrier when the printed circuit board is mounted on the antenna carrier.

In yet another variant, a top portion of the U-shaped radiator extends from a left-hand portion of the printed circuit board towards a mid-line of the printed circuit board.

In yet another variant, the antenna carrier includes one or more alignment posts, the one or more alignment posts being received within respective ones of one or more alignment holes on the printed circuit board when the printed circuit board is mounted to the antenna carrier.

In yet another aspect, an antenna design is disclosed.

In yet another aspect, an antenna carrier is disclosed.

In yet another aspect, methods of using and manufacturing the aforementioned systems, designs and antenna carriers are disclosed.

Other features and advantages of the present disclosure will immediately be recognized by persons of ordinary skill in the art with reference to the attached drawings and detailed description of exemplary implementations as given below.

### BRIEF DESCRIPTION OF DRAWINGS

The features, objectives, and advantages of the present disclosure will become more apparent from the detailed description set forth below when taken in conjunction with the drawings, wherein:

FIG. 1A is a front perspective view of a first exemplary antenna on magnetics system, in accordance with the principles of the present disclosure.

FIG. 1B is a rear perspective view of the antenna on magnetics system of FIG. 1A, in accordance with the principles of the present disclosure.

FIG. 2A is a front perspective view of the antenna system of FIG. 1A, in accordance with the principles of the present disclosure.

FIG. 2B is a rear perspective view of the antenna system of FIG. 2A, in accordance with the principles of the present disclosure.

FIG. 3 is a perspective view of the printed circuit board for the antenna system of FIG. 2A, in accordance with the principles of the present disclosure.

FIG. 4A is a rear perspective view of the antenna carrier for the antenna system of FIG. 2A, in accordance with the principles of the present disclosure.

FIG. 4B is a bottom perspective view of the antenna carrier for the antenna system of FIG. 2A, in accordance with the principles of the present disclosure.

FIG. 5 is a perspective view of the conductive foam used in the antenna on magnetics system of FIG. 1A, in accordance with the principles of the present disclosure.

FIG. 6A is a plot of return loss as a function of frequency for the antenna on magnetics system of FIGS. 1A and 1B, in accordance with the principles of the present disclosure.

FIG. 6B is a plot of antenna efficiency as a function of frequency for the antenna on magnetics system of FIGS. 1A and 1B, in accordance with the principles of the present disclosure.

FIG. 7 is a front perspective view of a second exemplary antenna on magnetics system, in accordance with the principles of the present disclosure.

FIG. 8A is a plot of return loss as a function of frequency for the antenna on magnetics system of FIG. 7, in accordance with the principles of the present disclosure.

FIG. 8B is a plot of antenna efficiency as a function of frequency for the antenna on magnetics system of FIG. 7, in accordance with the principles of the present disclosure.

FIG. 9 is a front perspective view of a third exemplary antenna on magnetics system, in accordance with the principles of the present disclosure.

FIG. 10A is a plot of return loss as a function of frequency for the antenna on magnetics system of FIG. 9, in accordance with the principles of the present disclosure.

FIG. 10B is a plot of antenna efficiency as a function of frequency for the antenna on magnetics system of FIG. 9, in accordance with the principles of the present disclosure.

### DETAILED DESCRIPTION

Detailed descriptions of the various embodiments and variants of the apparatus and methods of the present disclosure are now provided. It is noted that wherever practicable similar or like reference numbers may be used in the figures and may indicate similar or like functionality. The figures depict embodiments of an antenna on magnetics system, antenna systems for use with, for example, RJ-style connectors, antenna designs, and antenna carrier designs for purposes of illustration only. One skilled in the art will readily recognize from the following description that alternative embodiments of the structures and methods illustrated may be employed without necessarily departing from the principles described herein.

For example, while the various features discussed herein are primarily described in terms of a given frame of reference (e.g., top, bottom, left and right from a preestablished orientation), it would be readily apparent to one of ordinary skill given the contents of the present disclosure that this chosen frame of reference is arbitrary and other suitable descriptions in alternative frames of reference may be chosen to describe the various features of the systems and structures described herein. Moreover, while primarily discussed in terms of a specific wireless operating scenario, it would be readily apparent to one of ordinary skill given the contents of the present disclosure that the techniques described herein may be bodily incorporated in other antenna operating scenarios outside of the specific operating scenarios described herein. Additionally, while primarily described in the context of an antenna system for use with RJ-style connectors, it would be readily apparent to one of ordinary skill given the contents of the present disclosure that the antenna systems described herein may be utilized with other shielded electronic connectors and components. For example, the antenna systems described herein may be utilized with Small Form-factor Pluggable (“SFP”) connectors, Universal Serial Bus (“USB”) connectors, coaxial-style connectors, as well as other types of shielded connectors.

Exemplary Antenna Systems for Use with Integrated Connector Modules—

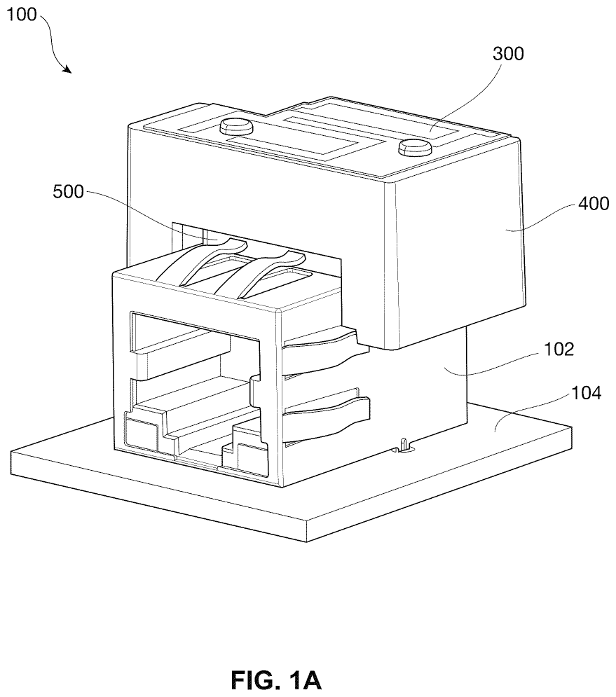

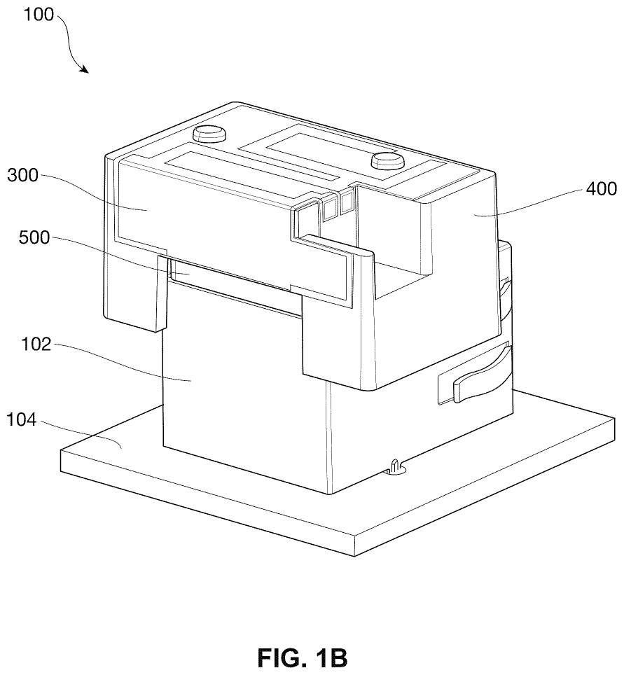

Referring now to FIGS. 1A-1B, an exemplary antenna on magnetics system 100 is shown and described in detail. The exemplary antenna on magnetics system 100 may include an RJ-style connector 102 mounted on a system printed circuit board 104. The system 100 may also include an antenna carrier 400 having a printed circuit board 300 disposed on the antenna carrier 400. In some implementations, the printed circuit board 300 is a flexible printed circuit board 300 which enables the printed circuit board 300 to be positioned around two or more faces of the antenna carrier 400. The system 100 may also include conductive foam 500 that is disposed between the shield of the RJ-style connector 102 and the ground portion of the printed circuit board 300. This conductive foam 500 enables the shielding located on the RJ-style connector 102 to act as, for example, a ground connection for the printed circuit board 300 located on the antenna carrier 400. In some variants, the conductive foam 500 may be obviated in favor of direct solder variants in which portions of the printed circuit board 300 may be directly connected to the outer shield of the RJ-style connector using, for example, a eutectic soldering operation such as hand-soldering or a solder reflow process as but a few examples.

While the system 100 is primarily described and illustrated as containing a printed circuit board 300 that is distinct from the underlying antenna carrier 400, it would be appreciated by one of ordinary skill given the contents of the present disclosure that the printed circuit board 300 may be integrated with the antenna carrier 400 in alternative implementations. For example, the antenna carrier 400 may be formed using a thermoplastic material that is doped with a metallic inorganic compound. Accordingly, the metallic inorganic compound may be activated by means of a laser which effectively allows the artwork of the printed circuit board 300 to be incorporated directly onto the antenna carrier 400 itself, using a process known as Laser Direct Structuring (LDS). Alternative additive processes such as Selective Laser Sintering (SLS) may be used in addition to, or alternatively from, the aforementioned LDS techniques referenced above in some implementations.

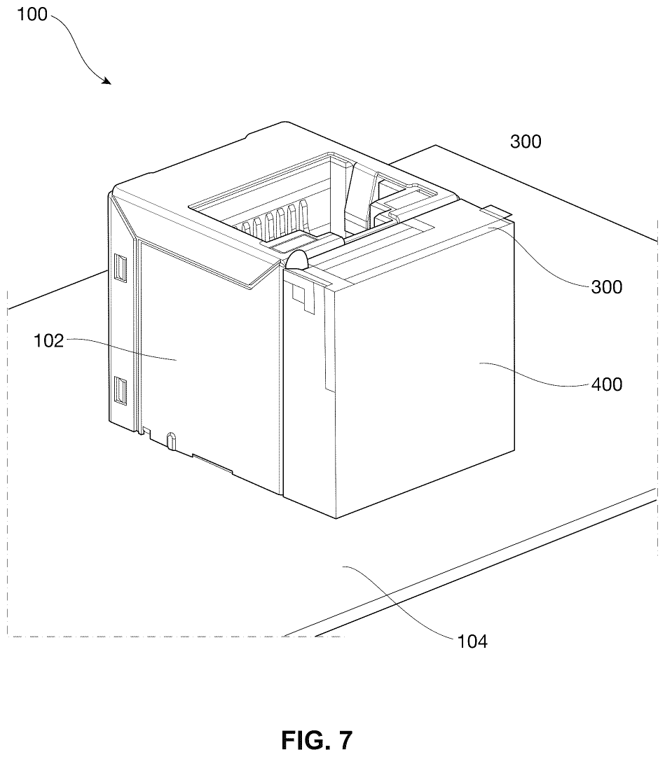

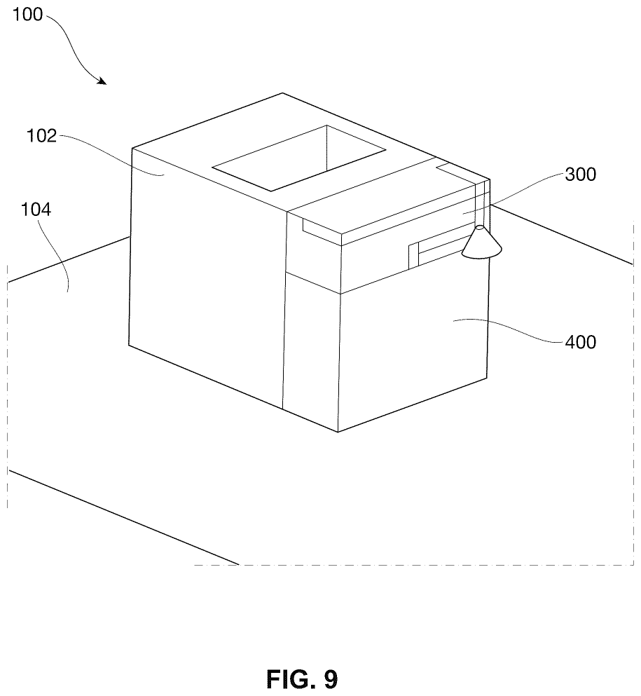

Moreover, while the RJ-style connector 102 illustrated in FIGS. 1A and 1B is a so-called 1×1 side entry latch-down through-hole mount RJ-style connector 102, it would be readily apparent to one of ordinary skill given the contents of the present disclosure that the RJ-style connector 102 may include latch-up configurations, may be incorporated into 1×N side entry arrays, 2×N side entry arrays, or M×N side entry arrays, may be included with top-entry RJ-style connectors and may include surface mount, pin-in-paste and press-fit variants in addition to, or alternatively from, the specific RJ-style connector 102 illustrated in FIGS. 1A and 1B. For example, the RJ-style connector 102 may include variants which operate in accordance with a 60 W Power-over-Ethernet (“PoE”) requirement. Moreover, while side entry (i.e., horizontal entry) connectors are primarily shown, it would be appreciated that top-entry (i.e., vertical entry) RJ-style connectors 102 (see e.g., FIGS. 7 and 9) may incorporate antenna systems on, for example, the backside of the connector. These and other variants would be readily apparent to one of ordinary skill given the contents of the present disclosure.

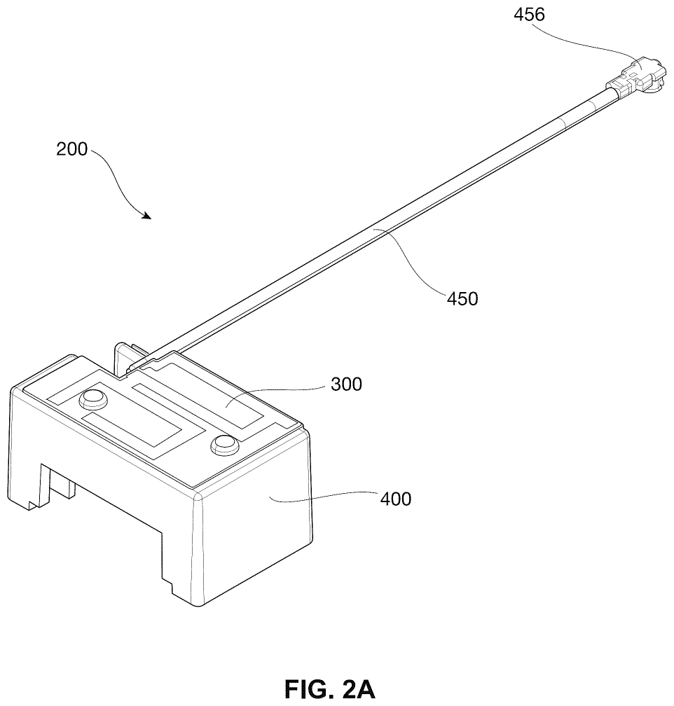

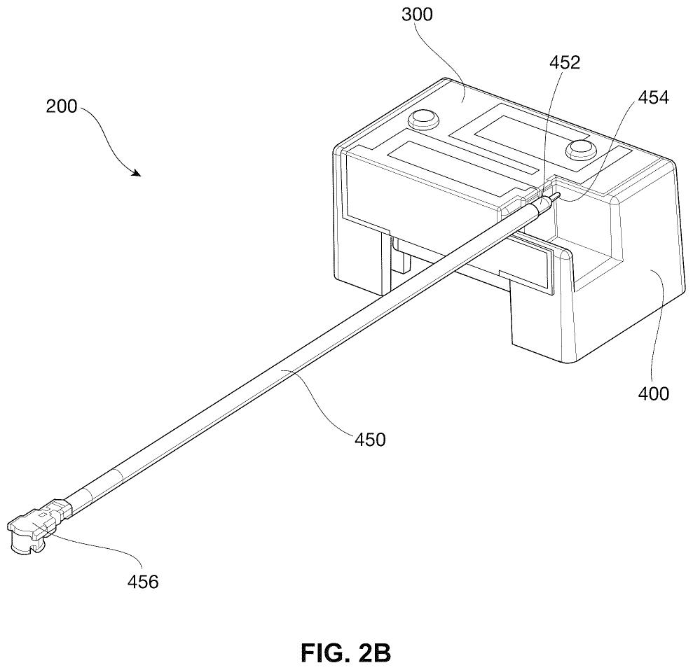

Referring now to FIGS. 2A and 2B, an exemplary antenna system 200 for use with, for example, the antenna on magnetics system 100 of FIGS. 1A and 1B is shown and described in detail. The antenna system 200 may include an antenna carrier 400 and a printed circuit board 300 which may include the aforementioned flexible printed circuit board 300 that enables the printed circuit board 300 to wrap around multiple faces of the antenna carrier 400. The antenna system 200 may also include a coaxial wire 450 that includes a coaxial connector 456 that is adapted for connection with, for example, the system printed circuit board (104, FIGS. 1A and 1B), or which may be connected with a separate transceiver, transmitter, or receiver which enables the coaxial wire to transmit signals to the printed circuit board 300 and/or receive signals from the printed circuit board 300. The coaxial wire 450 may include a coaxial ground connection 452 and a coaxial feed connection 454 which acts as the ground and feed connections, respectively, with the printed circuit board 300. In some implementations, the coaxial wire 450 may be secured to the printed circuit board 300 using an adhesive. For example, subsequent to soldering of the coaxial ground connection 452 to the ground connection 302 on the printed circuit board 300, an adhesive that is activated by ultraviolet (“UV”) light may added between the coaxial ground connection 452 and the printed circuit board 300 in order to strengthen the connection between the coaxial wire 450 and the printed circuit board 300. The printed circuit board 300 may operate in accordance with Wi-Fi internet telecommunications standards including, for example, Wi-Fi 2, Wi-Fi 5, Wi-Fi 6, Wi-Fi 7, cellular and other wireless communications protocols (e.g., from 400-8000 MHz).

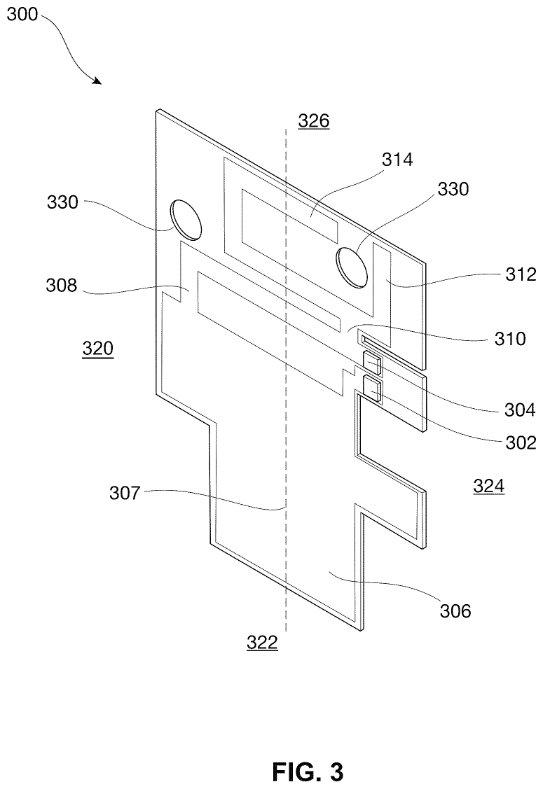

Referring now to FIG. 3, an exemplary printed circuit board 300 is shown and described in detail. The printed circuit board 300 illustrated in FIG. 3 is shown in its planar form (i.e., its form prior to being shaped around the multiple faces of the antenna carrier 400). For the purposes of illustration only, various illustrated portions of the plating present on the printed circuit board 300 will be described with reference to the bottom side 322, left side 320, right side 324, and top side 326. However, as alluded to supra, this naming convention is arbitrary and may be dependent upon the orientation of the viewer with respect to the printed circuit board 300. For example, the bottom side 322 may be the left side, right side, or top side dependent upon the orientation of the viewer in some circumstances. Accordingly, the reference frame of orientation described herein may differ in alternative frames of reference. Moreover, the artwork as illustrated in FIG. 3 could be mirrored in some implementations. For example, the artwork may be mirrored about center axis 307, dependent on, for example, the required positioning for the coaxial wire 450 (e.g., in instances in which the coaxial wire 450 is attached to the opposite side of the printed circuit board 300).

Referring again to FIG. 3, the printed circuit board 300 may include a ground connection 302 which is configured to be connected with the coaxial ground 452 of the coaxial wire 450. The printed circuit board 300 may also include a feed connection 304 which is configured to be connected with the coaxial feed 454 of the coaxial wire 450. The antenna ground 306 may be located beneath the ground connection 302 of the printed circuit board 300. The antenna ground 306 may be generally L-shaped (or T-shaped) meaning those portions of the antenna ground 306 may be wider closer to the ground connection 302 as compared with portions of the antenna ground 306 that are disposed further away from the ground connection 302. The printed circuit board 300 may also include an L-shaped segment 308 of metallized material that is disposed between the antenna ground 306 on the left side 320 of the printed circuit board 300 and the feed connection 304 located on the right side 324 of the printed circuit board 300. Located adjacent to the feed connection 304 may be a connecting segment 310 disposed between the L-shaped segment 308 and the L-shaped radiator 312 and U-shaped radiator 314. A gap may be present between the end of the U-shaped radiator 314 and the L-shaped radiator 312. While a specific radiating structure (or metallization) for the printed circuit board 300 is shown in FIG. 3, it would be readily apparent to one of ordinary skill given the contents of the present disclosure that alternative metallization patterns may be utilized dependent upon the operating characteristics of the antenna on the printed circuit board 300. For example, in dual/tri-band Wi-Fi implementations, a separate trace operating in the lower band as well as a separate trace operating in the higher band may be added in addition to, or alternatively than, the artwork illustrated in FIG. 3. As but another non-limiting example, the top portion of the U-shaped radiator 314 (i.e., the portion closes to the top side 326 of the printed circuit board 300) may be shorter in length than is shown in FIG. 3. For example, the top portion of the U-shaped radiator 314 may only extend part of the way from the left side 320 of the printed circuit board 300 towards the central axis 307. Moreover, in some implementations the L-shaped radiator 312 may be shorter in length than as shown in FIG. 3, so that the L-shaped radiator 312 does not extend as far towards the top side 326 of the printed circuit board 300 (e.g., the L-shaped radiator 312 may only extend towards the mid-line of the adjacent alignment hole 330). In some implementations, the feed connection 304 and the ground connection 302 may extend further towards the right side 324 of the printed circuit board 300. These and other variants would be readily apparent to one of ordinary skill given the contents of the present disclosure.

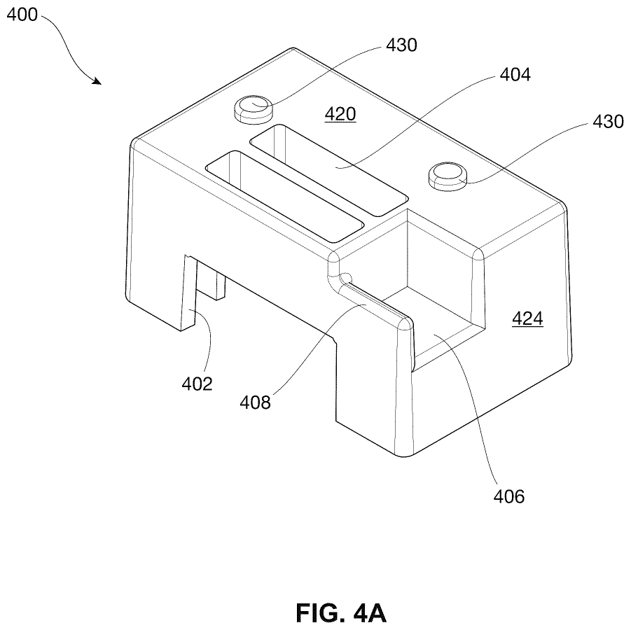

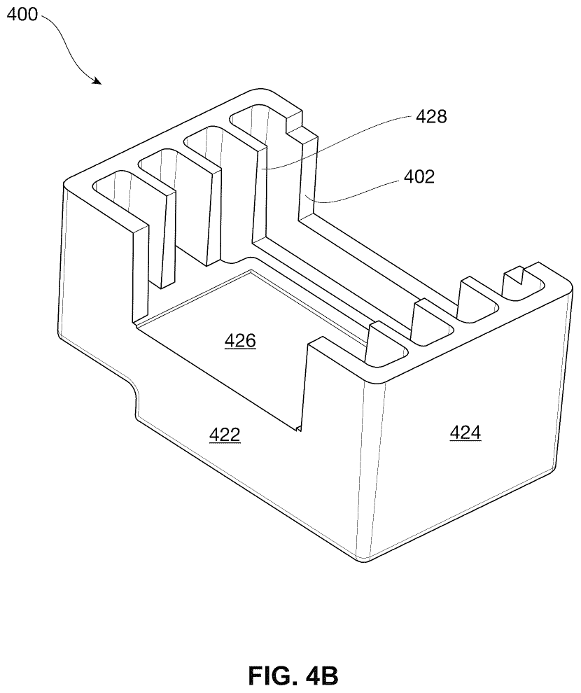

Referring now to FIGS. 4A and 4B, the top side and the underside, respectively, of an exemplary antenna carrier 400 are shown and described in detail. The antenna carrier 400 may include an RJ-style connector clearance area 402 which may be sized in accordance with the underlying physical geometry of the RJ-style connector 102 being used with the antenna on magnetics system 100. As perhaps best seen in FIG. 4A, the antenna carrier 400 may include a connection clearance area 406 disposed within the side surface 424 and the top surface 420 of the antenna carrier 400. On the back surface 422 of the antenna carrier 400, a coaxial clearance ledge 408 may be included which allows, for example, portions of the coaxial wire 450 to be received within the connection clearance area 406 while minimizing (or eliminating) intrusion of the coaxial wire 450 above the top surface 420 of the antenna carrier 400. The top surface 420 of the antenna carrier 400 may include clearance slots 404 as well as a pair of alignment posts 430. While FIG. 4A illustrates that the antenna carrier 400 includes two (2) clearance slots 404 and two (2) alignment posts 430, it would be recognized by one or ordinary skill given the contents of the present disclosure that the number of clearance slots 404 and alignment posts 430 may be less than two (2) (e.g., one (1) or zero in alternative implementations), or more than two (2) (e.g., three (3) or more clearance slots 404 and/or alignment posts 430) may be utilized in some variants. Moreover, the number of clearance slots 404 and the number of alignment posts 430 may not equal one another. For example, one clearance slot 404 and three (3) or more alignment posts 430 may be utilized in some embodiments. These and other variants would be readily recognized by one of ordinary skill given the contents of the present disclosure.

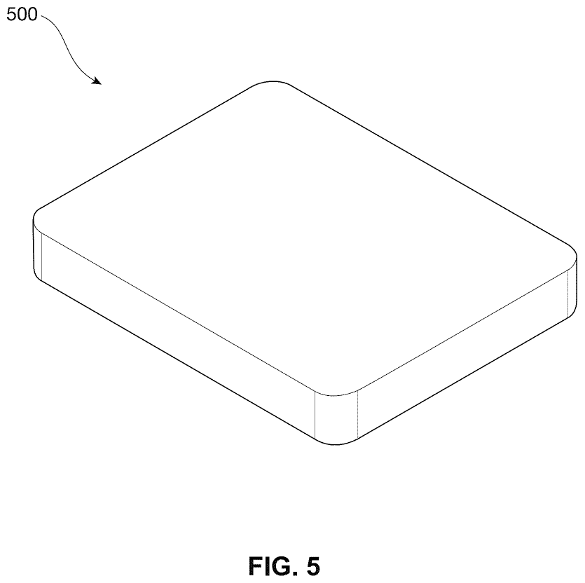

Referring now to FIG. 4B, various features on the underside of the antenna carrier 400 are now shown and described in detail. On the underside of the antenna carrier 400, within the RJ-style connector clearance area 402, a PCB clearance area 426 may be incorporated into the antenna carrier 400. The PCB clearance area 426 may be sized to accommodate that portion of the printed circuit board 300 that is intended to be placed in the underside of the antenna carrier 400. The underside of the antenna carrier 400 may also incorporate several antenna carrier ribs 428. One primary purpose for these antenna carrier ribs 428 is to ensure the thickness of the walls for the antenna carrier 400 remains relatively consistent throughout, which is advantageous where the antenna carrier is formed from an injection-molded polymer material. The incorporation of these antenna carrier ribs 428 may also reduce the amount of material required to form the antenna carrier, thereby reducing costs associated with antenna carrier 400 production. FIG. 5 illustrates an exemplary piece of conductive foam 500 which may be generally disposed in the area of the PCB clearance area 426 of the antenna carrier. As previously alluded to above, the conductive foam 500 is intended to provide a reliable connection between the antenna ground (306, FIG. 3) and the electromagnetic shielding located on the RJ-style connector (102, FIGS. 1A and 1B).

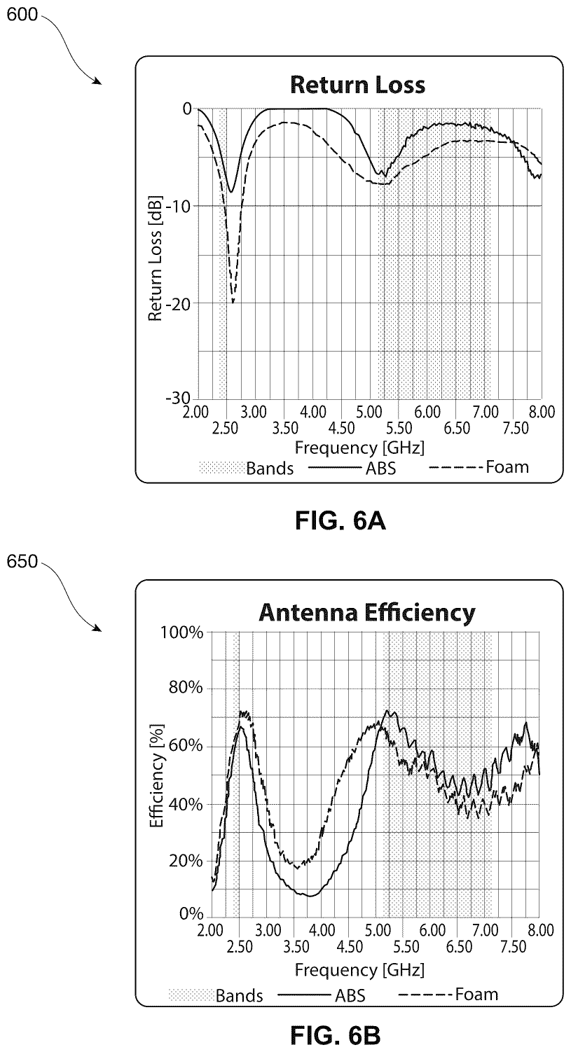

Referring now to FIG. 6A, a plot 600 of return loss as a function of frequency for the exemplary antenna on magnetics system 100 of FIGS. 1A and 1B is shown, while FIG. 6B is a plot 650 of antenna efficiency as a function of frequency for the exemplary antenna on magnetics system 100 of FIGS. 1A and 1B is shown.

Referring now to FIG. 7, another exemplary antenna on magnetics system 100 is shown and described in detail. The exemplary antenna on magnetics system 100 may include an RJ-style connector 102 mounted on a system printed circuit board 104. As illustrated in FIG. 7, the RJ-style connector 102 illustrated in FIG. 7 is a top-entry (or vertically mounted) RJ-style connector 102. The system 100 may also include an antenna carrier 400 having a printed circuit board 300 disposed on the antenna carrier 400. In some implementations, the printed circuit board 300 is a flexible printed circuit board 300 which enables the printed circuit board 300 to be positioned around multiple faces of the antenna carrier 400. As shown in FIG. 7, the metallization (or antenna design) located on the printed circuit board 300 is located on the top surface 704 and well as the left surface 702. Note that the metallization (or antenna design) located on the printed circuit board 300 is not located on the front surface 706 of the antenna carrier 400. The system 100 may also include conductive foam 500 that is disposed between the shield of the RJ-style connector 102 and the ground portion of the printed circuit board 300. This conductive foam 500 enables the shield located on the RJ-style connector 102 to act as a ground connection for the printed circuit board 300 located on the antenna carrier 400. In some variants, the conductive foam 500 may be obviated in favor of direct solder variants in which portions of the printed circuit board 300 may be directly connected to the outer shield of the RJ-style connector using, for example, a eutectic soldering operation such as hand-soldering or a solder reflow process as but a few examples.

While the system 100 is primarily described and illustrated as containing a printed circuit board 300 that is distinct from the underlying antenna carrier 400, it would be appreciated by one of ordinary skill given the contents of the present disclosure that the printed circuit board 300 may be integrated with the antenna carrier 400 in alternative implementations. For example, the antenna carrier 400 may be formed using a thermoplastic material that is doped with a metallic inorganic compound. Accordingly, the metallic inorganic compound may be activated by means of a laser which effectively allows the artwork of the printed circuit board 300 to be incorporated directly onto the antenna carrier 400 itself, using a process known as Laser Direct Structuring (LDS). Alternative additive processes such as Selective Laser Sintering (SLS) may be used in addition to, or alternatively from, the aforementioned LDS techniques referenced above in some implementations.

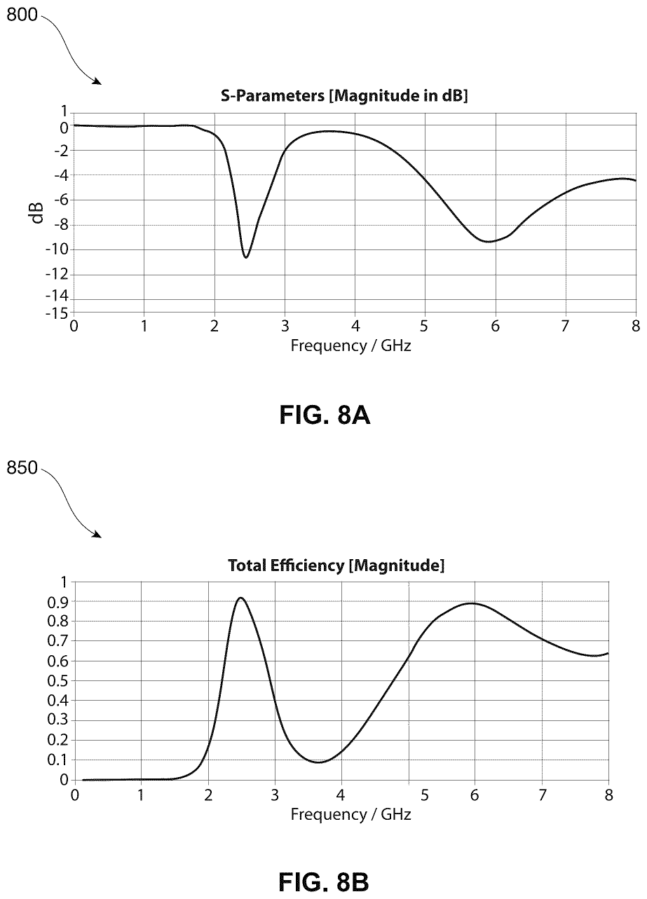

Referring now to FIG. 8A, a plot 800 of return loss as a function of frequency for the exemplary antenna on magnetics system 100 of FIG. 7 is shown. Referring now to FIG. 8B, a plot 850 of antenna efficiency as a function of frequency for the exemplary antenna on magnetics system 100 of FIG. 7 is shown.

Referring now to FIG. 9, yet another exemplary antenna on magnetics system 100 is shown and described in detail. The exemplary antenna on magnetics system 100 may include an RJ-style connector 102 mounted on a system printed circuit board 104. As illustrated in FIG. 9, and similar to the embodiment of FIG. 7, the RJ-style connector 102 illustrated in FIG. 9 is a top-entry (or vertically mounted) RJ-style connector 102. The system 100 may also include an antenna carrier 400 having a printed circuit board 300 disposed on the antenna carrier 400. In some implementations, the printed circuit board 300 is a flexible printed circuit board 300 which enables the printed circuit board 300 to be positioned around multiple faces of the antenna carrier 400. As shown in FIG. 9, the metallization (or antenna design) located on the printed circuit board 300 is located on the top surface 704, the left surface 702, as well as the front surface 706 of the antenna carrier 400. The system 100 may also include conductive foam 500 that is disposed between the shield of the RJ-style connector 102 and the ground portion of the printed circuit board 300. This conductive foam 500 enables the shield located on the RJ-style connector 102 to act as a ground connection for the printed circuit board 300 located on the antenna carrier 400. In some variants, the conductive foam 500 may be obviated in favor of direct solder variants in which portions of the printed circuit board 300 may be directly connected to the outer shield of the RJ-style connector using, for example, a eutectic soldering operation such as hand-soldering or a solder reflow process as but a few examples.

While the system 100 is primarily described and illustrated as containing a printed circuit board 300 that is distinct from the underlying antenna carrier 400, it would be appreciated by one of ordinary skill given the contents of the present disclosure that the printed circuit board 300 may be integrated with the antenna carrier 400 in alternative implementations. For example, the antenna carrier 400 may be formed using a thermoplastic material that is doped with a metallic inorganic compound. Accordingly, the metallic inorganic compound may be activated by means of a laser which effectively allows the artwork of the printed circuit board 300 to be incorporated directly onto the antenna carrier 400 itself, using a process known as Laser Direct Structuring (LDS). Alternative additive processes such as Selective Laser Sintering (SLS) may be used in addition to, or alternatively from, the aforementioned LDS techniques referenced above in some implementations.

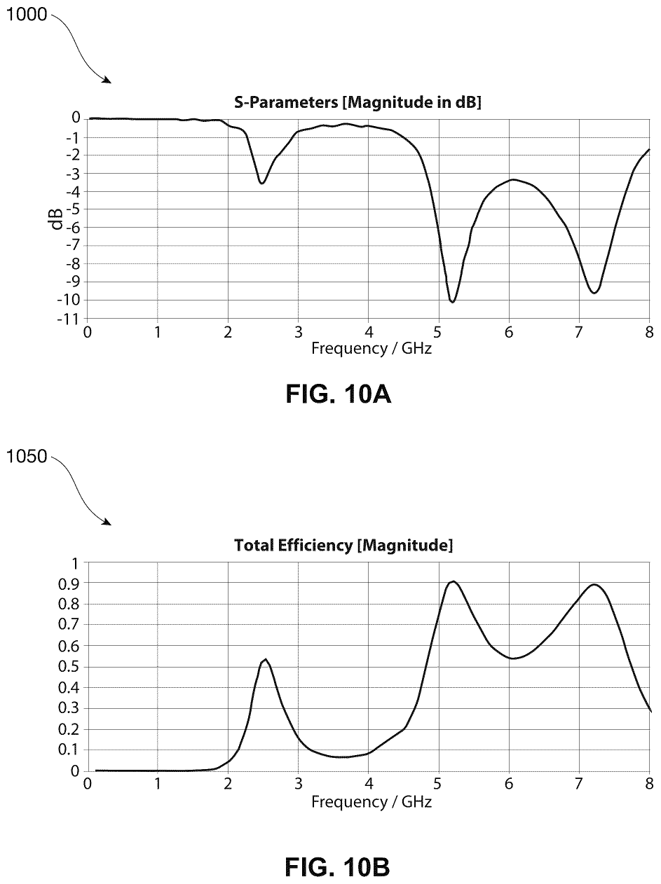

Referring now to FIG. 10A, a plot 1000 of return loss as a function of frequency for the exemplary antenna on magnetics system 100 of FIG. 9 is shown. Referring now to FIG. 10B, a plot 1050 of antenna efficiency as a function of frequency for the exemplary antenna on magnetics system 100 of FIG. 9 is shown.

It will be recognized that while certain aspects of the present disclosure are described in terms of specific design examples, these descriptions are only illustrative of the broader methods of the disclosure and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

1. An antenna system for use with an RJ-style connector, the antenna system comprising:
an antenna carrier comprising an RJ-style connector clearance area, the RJ-style connector clearance area being sized to accommodate portions of the RJ-style connector;
a printed circuit board that is configured to be disposed about a plurality of distinct sides of the antenna carrier; and
a coaxial wire, the coaxial wire being connected with the printed circuit board.

2. The antenna system of claim 1, wherein the antenna carrier comprises a top side that is oriented parallel with a top side of the RJ-style connector, a back side that is oriented generally orthogonal with the top side of the antenna carrier, and a bottom side that is oriented adjacent to the RJ-style connector when the antenna carrier is mounted thereon, the bottom side being parallel with the top side of the antenna carrier.

3. The antenna system of claim 2, wherein the printed circuit board comprises a flexible printed circuit board and the plurality of distinct sides of the antenna carrier comprises the top side of the antenna carrier, the back side of the antenna carrier, and the bottom side of the antenna carrier.

4. The antenna system of claim 3, wherein the printed circuit board comprises an antenna ground, the antenna ground being located on both the back side of the antenna carrier and the bottom side of the antenna carrier when the printed circuit board is mounted on the antenna carrier.

5. The antenna system of claim 4, wherein the printed circuit board comprises a U-shaped radiator and an L-shaped radiator, the U-shaped radiator and the L-shaped radiator being located on the top side of the antenna carrier when the printed circuit board is mounted on the antenna carrier.

6. The antenna system of claim 5, wherein the antenna carrier comprises a connection clearance area and a coaxial clearance ledge, the connection clearance area and the coaxial clearance ledge enabling the coaxial wire to be attached to the printed circuit board at a position below the top side of the antenna carrier.

7. The antenna system of claim 6, wherein the printed circuit board comprises a ground connection for the coaxial wire and a feed connection for the coaxial wire, the ground connection and the feed connection being oriented orthogonal with the top side of the antenna carrier when the printed circuit board is mounted on the antenna carrier.

8. The antenna system of claim 7, wherein the ground connection for the coaxial wire and the feed connection for the coaxial wire are also oriented orthogonal with the back side of the antenna carrier when the printed circuit board is mounted on the antenna carrier.

9. The antenna system of claim 8, wherein a top portion of the U-shaped radiator extends from a left-hand portion of the printed circuit board towards a mid-line of the printed circuit board.

10. The antenna system of claim 9, wherein the antenna carrier comprises one or more alignment posts, the one or more alignment posts being received within respective ones of one or more alignment holes on the printed circuit board when the printed circuit board is mounted to the antenna carrier.

11. An antenna on magnetics system, the antenna on magnetics system comprising:
an RJ-style connector; and
an antenna system, the antenna system comprising:
an antenna carrier comprising an RJ-style connector clearance area, the RJ-style connector clearance area being sized to accommodate portions of the RJ-style connector;
a printed circuit board that is configured to be disposed about a plurality of distinct sides of the antenna carrier; and
a coaxial wire, the coaxial wire being connected with the printed circuit board.

12. The antenna on magnetics system of claim 11, wherein the antenna carrier comprises a top side that is oriented parallel with a top side of the RJ-style connector, a back side that is oriented generally orthogonal with the top side of the antenna carrier, and a bottom side that is oriented adjacent to the RJ-style connector when the antenna carrier is mounted thereon, the bottom side being parallel with the top side of the antenna carrier.

13. The antenna on magnetics system of claim 12, wherein the printed circuit board comprises a flexible printed circuit board and the plurality of distinct sides of the antenna carrier comprises the top side of the antenna carrier, the back side of the antenna carrier, and the bottom side of the antenna carrier.

14. The antenna on magnetics system of claim 13, wherein the printed circuit board comprises an antenna ground, the antenna ground being located on both the back side of the antenna carrier and the bottom side of the antenna carrier when the printed circuit board is mounted on the antenna carrier.

15. The antenna on magnetics system of claim 14, wherein the printed circuit board comprises a U-shaped radiator and an L-shaped radiator, the U-shaped radiator and the L-shaped radiator being located on the top side of the antenna carrier when the printed circuit board is mounted on the antenna carrier.

16. The antenna on magnetics system of claim 15, wherein the antenna carrier comprises a connection clearance area and a coaxial clearance ledge, the connection clearance area and the coaxial clearance ledge enabling the coaxial wire to be attached to the printed circuit board at a position below the top side of the antenna carrier.

17. The antenna on magnetics system of claim 16, wherein the printed circuit board comprises a ground connection for the coaxial wire and a feed connection for the coaxial wire, the ground connection and the feed connection being oriented orthogonal with the top side of the antenna carrier when the printed circuit board is mounted on the antenna carrier.

18. The antenna on magnetics system of claim 17, wherein the ground connection for the coaxial wire and the feed connection for the coaxial wire are also oriented orthogonal with the back side of the antenna carrier when the printed circuit board is mounted on the antenna carrier.

19. The antenna on magnetics system of claim 18, wherein a top portion of the U-shaped radiator extends from a left-hand portion of the printed circuit board towards a mid-line of the printed circuit board.

20. The antenna on magnetics system of claim 19, wherein the RJ-style connector comprises shielding and conductive foam is disposed between the RJ-style connector shielding and the antenna ground disposed on the bottom side of the antenna carrier.
